(19) United States
(12) Patent Application Publication
(10) Pub. No.: US 2026/0211378 A1
(43) Pub. Date: Jul. 23, 2026

(54) HYBRID COMPUTE METHODS FOR WEARABLE ON-BODY DETECTION UTILIZING MULTIPLE SENSING MODALITIES

(71) Applicant: Verily Life Sciences LLC, Dallas, TX (US)

(72) Inventors: Miles Bennett, San Francisco, CA (US); Stefanie Nickels, Westford, MA (US); Hamed Sadeghi, San Francisco, CA (US)

(73) Assignee: Verily Life Sciences LLC, Dallas, TX (US)

(21) Appl. No.: 19/136,648

(22) PCT Filed: Dec. 22, 2023
(86) PCT No.: PCT/US2023/085744

§ 371 Date: Jun. 6, 2025

Related U.S. Application Data
(60) Provisional application No. 63/436,235, filed on Dec. 30, 2022.

(51) Int. Cl. G04G 19/12; G04G 21/02; G06F 1/16; G06F 1/3231; G06F 1/3234; G06F 3/01

(52) U.S. Cl. CPC G04G 19/12; G04G 21/025; G06F 1/163; G06F 1/3231; G06F 1/3234; G06F 3/015

(57) ABSTRACT

The present disclosure relates to systems and methods for detecting when a wearable device is being worn by a user. The systems and methods include receiving signal data from a first set of biosensors of a plurality of biosensors in a wearable device, determining an on-body or an offbody state of the wearable device based on the signal data, responsive to determining the onbody state, and enabling all of the plurality of biosensors on-body to record signal data from the plurality of biosensors. The system and methods also include, responsive to determining the offbody state, disabling a second set of the plurality of biosensors to stop recording signal data from the second of the plurality of biosensors, providing the on-body state or the off-body state to a data analysis engine, and providing the recorded signal data from the plurality of biosensors to the data analysis engine.

### CROSS REFERENCE TO RELATED APPLICATIONS

This international application claims priority to U.S. Provisional Application No. 63/436,235, filed on Dec. 30, 2022, the disclosure of which is herein incorporated by reference in its entirety for all purposes.

### APPENDIX

The present disclosure includes Appendix A, the entire contents of which are considered part of the disclosure and are incorporated by reference in its entirety for all purposes.

### FIELD OF THE INVENTION

The present disclosure relates to on-body detection suitable for detecting when a wearable device is being worn by a user. In particular, the present disclosure relates to on-wrist detection for a watch being worn by a user.

### BACKGROUND

Generally, wearable devices are designed to last for long periods of time without charging or battery replacement while providing useful information to a user. However, as wearable devices become more sophisticated and include a larger number of sensors and types of sensors, the battery life of the devices suffer. Additionally, wearable devices are providing more information to users, requiring larger memory and computational resources, which also limits battery life. Wearable devices can either be designed with limited functionality to last longer or to have more sensors and analytics available but have limited power duration, thereby requiring more frequent charging. Additionally, it can be computationally expensive and high energy consumption to track when a device is or is not being worn by a user, for example, for downstream applications such as accurate data acquisition, compliance, etc.

### SUMMARY

There is a need for optimizing operation of a wearable device and accurately determining when a wearable device is and is not being worn by a user. The present disclosure is directed toward further solutions to address this need, in addition to having other desirable characteristics. Specifically, the present disclosure relates to systems and methods for detecting when a participant is wearing or not wearing the wearable device. Detecting when a user is and is not wearing the wearable device is critical for accurate data collection for use by downstream wearable device algorithms.

In various embodiments, a method is provided. The methods includes receiving signal data from a first set of biosensors of a plurality of biosensors in a wearable device, determining an on-body or an off-body state of the wearable device based on the signal data, and responsive to determining the on-body state, enabling all of the plurality of biosensors on-body to record signal data from the plurality of biosensors. The method also includes responsive to determining the off-body state, disabling a second set of the plurality of biosensors to stop recording signal data from the second of the plurality of biosensors, providing the on-body state or the off-body state to a data analysis engine, and providing the recorded signal data from the plurality of biosensors to the data analysis engine.

In some embodiments, the first set of biosensors is an electrodermal activity (EDA) sensor and the second set of the plurality of biosensors include at least one of a photoplethysmography (PPG) sensor, an inertial measurement unit (IMU) sensor, and an electrocardiogram (ECG) sensor. The signal data from the EDA sensor can include an absolute magnitude at a current time and a standard deviation over a predetermined period of time. When the absolute magnitude is greater than approximately 500-800 and the standard deviation is less than 2 over the predetermined period of time of approximately 1400-1600 ms then can determine the on-body state. The method can include removing off-body labels if a mean value for the absolute magnitude is not equal to zero over the predetermined period of time. The wearable device can be a smart watch.

In various embodiments, a device is provided. The device includes a plurality of biosensors, a non-transitory computer-readable medium, and a processor communicatively coupled to the plurality of biosensors and the non-transitory computer-readable medium. The processor is configured to execute processor-executable instructions stored in the non-transitory computer-readable medium to receive signal data from a first set of biosensors of a plurality of biosensors in a wearable device, determine an on-body or an off-body state of the wearable device based on the signal data, responsive to determining the on-body state, enabling the plurality of biosensors on-body to record signal data from the plurality of biosensors, responsive to determining the off-body state, disabling a second set of the plurality of biosensors to stop recording signal data from the second set of the plurality of biosensors, provide the on-body state or the off-body state to a data analysis engine; and provide the recorded signal data from the plurality of biosensors to the data analysis engine.

In some embodiments, the first set of biosensors is an electrodermal activity (EDA) sensor and the second set of the plurality of biosensors include at least a photoplethysmography (PPG) sensor, an inertial measurement unit (IMU) sensor, and an electrocardiogram (ECG) sensor. The signal data from the EDA sensor can include an absolute magnitude at a current time and a standard deviation over a predetermined period of time. When the absolute magnitude is greater than approximately 500-800 and the standard deviation is less than 2 over the predetermined period of time of approximately 1400-1600 ms then can determine the on-body state. The method can include removing off-body labels if a mean value for the absolute magnitude is not equal to zero over the predetermined period of time. The wearable device can be a smart watch.

In various embodiments, a non-transitory computer readable medium configured to store at least executable instructions, wherein the executable instructions, when executed by a processor of a wearable computing device, cause the wearable computing device to perform functions including receiving signal data from a first set of biosensors of a plurality of biosensors in a wearable device, determining an on-body or an off-body state of the wearable device based on the signal data, responsive to determining the on-body state, enabling the plurality of biosensors on-body to record signal data from the plurality of biosensors, responsive to determining the off-body state, disabling a second set of the plurality of biosensors to stop recording signal data from the second set of the plurality of biosensors, providing the on-body state or the off-body state to a data analysis engine, and provide the recorded signal data from the plurality of biosensors to the data analysis engine.

In some embodiments, the first set of biosensors is an electrodermal activity (EDA) sensor and the second set of the plurality of biosensors include at least a photoplethysmography (PPG) sensor, an inertial measurement unit (IMU) sensor, and an electrocardiogram (ECG) sensor. The signal data from the EDA sensor can include an absolute magnitude at a current time and a standard deviation over a predetermined period of time. When the absolute magnitude is greater than approximately 500-800 and the standard deviation is less than 2 over the predetermined period of time of approximately 1400-1600 ms then can determine the on-body state. The method can include removing off-body labels if a mean value for the absolute magnitude is not equal to zero over the predetermined period of time. The wearable device can be a smart watch.

In various embodiments, method is provided. The method includes receiving one or more high sensitivity on or off labels from an on-body detection module on a wearable device, receiving sensor data for one or more biosensors on the wearable device, and providing the sensor data to a remote on-body detection module separate from the wearable device. The method also includes receiving one or more high specificity on or off labels from the remote on-body detection module, updating the on the one or more high sensitivity on or off labels using the one or more high specificity on or off labels, and providing the signal data with the updated high sensitivity on or off labels to one or more downstream applications.

In some embodiments, the method can further incldue performing a predictive analysis on the updated high sensitivity on or off labels to determine next states of the wearable device. The predictive analysis can employ a hidden Markov model and next states can include one or more of on-body vigorous motion, on-body light motion, on-body rest, off-body rest, and off-body motion.

In various embodiments, a system is provided. The system includes a wearable device configures to receive signal data from a first set of biosensors of a plurality of biosensors in a wearable device, determine an on-body or an off-body state of the wearable device based on the signal data, responsive to determining the on-body state, enabling all of the plurality of biosensors on-body to record signal data from the plurality of biosensors, responsive to determining the off-body state, disabling a second set of the plurality of biosensors to stop recording signal data from the second of the plurality of biosensors, provide the on-body state or the off-body state to a data analysis engine, and provide the recorded signal data from the plurality of biosensors to the data analysis engine.

The system also includes a data analysis engine. the data analysis engine is configured to receive one or more high sensitivity on or off labels from an on-body detection module on a wearable device, receiving sensor data for one or more biosensors on the wearable device, provide the sensor data to a remote on-body detection module separate from the wearable device, receive one or more high specificity on or off labels from the remote on-body detection module, update the on the one or more high sensitivity on or off labels using the one or more high specificity on or off labels, and provide the signal data with the updated high sensitivity on or off labels to one or more downstream applications.

### BRIEF DESCRIPTION OF THE FIGURES

These and other characteristics of the present disclosure will be more fully understood by reference to the following detailed description in conjunction with the attached drawings, in which:

FIGS. 1A, 1B, and 1C are a diagrams of example systems for use in accordance with the present disclosure;

FIG. 2 is a diagram of an example wearable device architecture for use in accordance with the present disclosure;

FIG. 3 is a diagram of an example system for use in accordance with the present disclosure;

FIG. 4 is a diagram of an example system for use in accordance with the present disclosure; and

FIG. 5 is a diagram of an example diagram for determining an on-body state in accordance with the present disclosure.

FIG. 6 is a diagram of an example diagram for determining an on-body state in accordance with the present disclosure;

FIG. 7 is a diagram of an example diagram a diagram of an example diagram for determining an on-body state in accordance with the present disclosure;

FIG. 8 is an example diagram a diagram of an example diagram for determining on-body states in accordance with the present disclosure;

FIGS. 9A and 9B are flow charts depicting example operation in accordance with the present disclosure; and

FIG. 10 is an example computing architecture in accordance with the present disclosure.

### DETAILED DESCRIPTION

An illustrative embodiment of the present disclosure relates to systems and methods for accurately predicting when a device is being worn by a user. The present disclosure makes use of a unique combination of determination mechanisms to both accurately determine when a wearable device is being worn as well as limiting complexity and power usage of the wearable device itself. The determination mechanism can be implemented in a two-step process, one step performed by the wearable device and the other step performed by a remote device. The first step includes the wearable device performing a highly-sensitive determination process which has been simplified because additional processing will occur at the remote device. The highly-sensitive determination can be optimized to detect nearly 100% of the times in which the wearable device is being worn. High sensitivity is important because most other sensor data collection may be turned off when the wearable device is determined to not be worn. Powering down other sensors may be implemented to save battery and memory usage of the wearable device. However, if sensors are powered off when it is determined that a wearable device is not being worn, an incorrect determination of the wearable device not being worn may be costly as it leads to data loss. As such, implementing a high-sensitivity process ensures that data collection will occur whenever the device is being worn, while the data may also include instances in which the wearable device is not being worn (e.g., false). In other words, implementing the determination process that is optimized for high-sensitivity ensures that it rarely misses identifying when the wearable device is being worn. However, despite the high-sensitivity process being highly accurate, it is important to eliminate any incorrect determinations.

The second step includes a high specificity determination process executed off of the wearable device by a remote device. The second step is optimized to override, filter, and/or remove the false positives and/or negatives that may be output by the first step. In some instances, the second step can be performed such that it is not aware or concerned with the results of the first step and merely processes the signal data that has been received to make its own determination with a higher level of specificity than the process in the first step. The specificity relates to how often the first step incorrectly determined that a wearable device was being worn when in reality it was not. The high specificity determination process can be performed by a separate device that does not have the same power, processing, memory, etc. limitations as the wearable device such that more complex and intensive computing can be performed on data that is received. Additionally, the second step can take advantage of a larger set of data that was not used by the wearable device in the first step.

The outputs of both the first step and the second step can be provided to a data analysis system (e.g., a service provider) to be saved with the corresponding sensor data. While the resulting on-body/off-body determinations provided by the first process and second process can both be saved, the results from the second process can be given priority. In particular, the results from the second step will take priority over the results of the first step such that any results that do not match will be superseded by the results of the second step. As a result, the present disclosure takes advantage of a two-step process in which a first process is performed on the wearable device (e.g., on firmware), using one type of sensor (e.g., an electrodermal activity (EDA)) modality, and tuned for high sensitivity to detect on-body events. This process can be useful in determining when to activate and record data from a larger collection of the available sensors. The second process is tuned for high specificity and is performed on a more complex computing device using multiple sensor modalities (e.g., EDA, inertial measurement unit (IMU), photoplethysmography (PPG), electrocardiogram (ECG)) to filter, ignore, or otherwise remove false positives and/or negatives tagged by the first process to improve accuracy of on-body predictions. Since on-body detection affects all downstream algorithms (pulse rate, step count, etc.), small improvements in the accuracy of such predictions can have a considerable impact on the overall performance. For example, with large data sets, a 1% improvement can allow the capture of millions of data points which otherwise would have been lost. Additionally, by sharing the computational load between the two devices, and limiting the duration in which all the sensors are actively providing data, the wearable device is able to be operated with increased battery life, decreased memory usage, etc. resulting in a more user-friendly wearable device.

Although the present disclosure discusses a two-step process using an on-body detection module on the wearable device and a remote on-body detection module separate from the wearable device, the present disclosure could be operated using either of the processes individually without the other step. For example, the remote on-body detection module could process received signal data and make the only on-body or off-body determination.

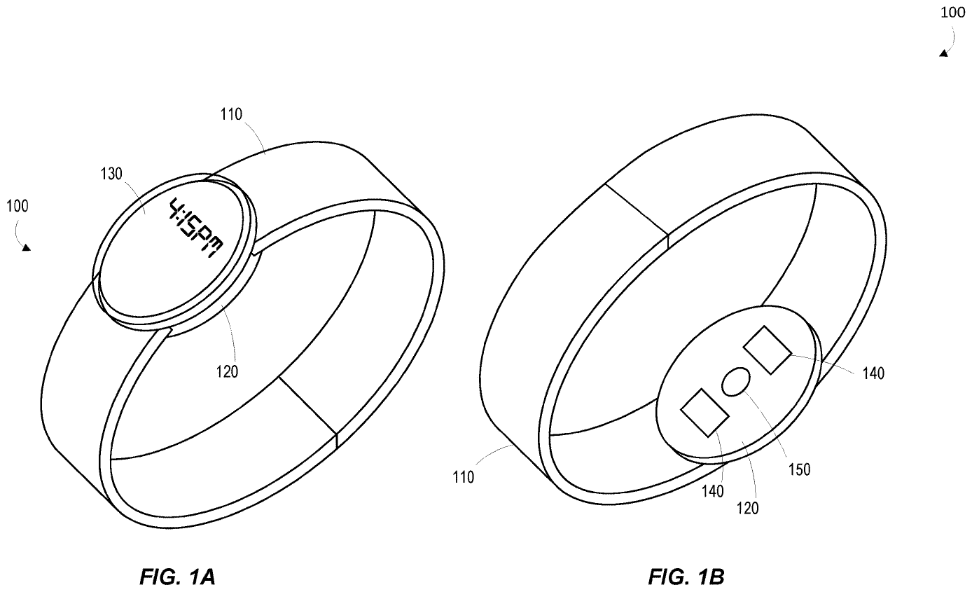

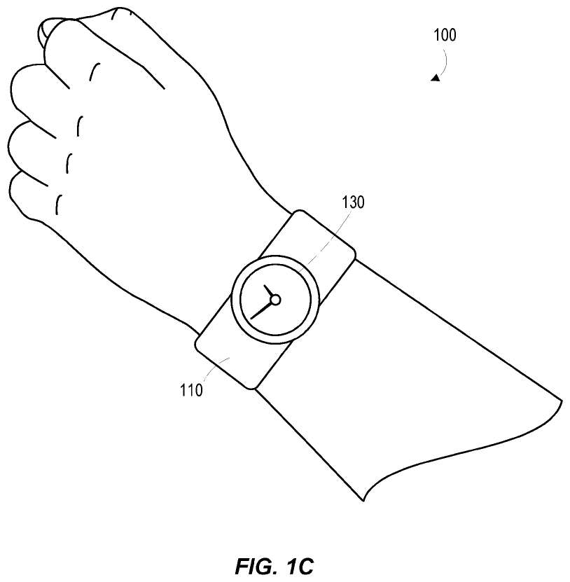

FIGS. 1A through 10, wherein like parts are designated by reference numerals throughout, illustrate an example embodiment or embodiments of improved operation for wearable devices, according to the present disclosure. Although the present disclosure will be described with reference to the example embodiment or embodiments illustrated in the figures, it should be understood that many alternative forms can embody the present disclosure. One of skill in the art will additionally appreciate different ways to alter the parameters of the embodiment(s) disclosed, such as the size, shape, or type of elements or materials, in a manner still in keeping with the spirit and scope of the present disclosure.

Referring to FIGS. 1A and 1B, an example wearable device (or “wearable”) 100 for use in accordance with the present disclosure is depicted. In some embodiments, the wearable device 100 is a smart watch. The term “wearable device,” as used in this disclosure, refers to any device that is capable of being worn at, on or in proximity to a body surface, such as a wrist, ankle, waist, chest, or other body part. The wearable device 100 may have a variety of functions, including, but not limited to: keeping time; monitoring a user's physiological signals and providing health-related information based at least in part on those signals; communicating (in a wired or wireless fashion) with other electronic devices, which may be different types of devices having different functionalities; providing alerts to a user, which may include audio, haptic, visual, and/or other sensory output, any or all of which may be synchronized with one another; visually depicting data on a display; gathering data from one or more sensors that may be used to initiate, control, or modify operations of the device; determining a location of a touch on a surface of the device and/or an amount of force exerted on the device, and using either or both as input; accepting voice input to control one or more functions; accepting tactile input to control one or more functions; etc.

Although the present disclosure is discussed with respect to a smart watch worn on a user's wrist, any combination of wearable devices 100 could be used at different locations without departing from the scope of the present invention. For example, the wearable device could be any combination of smart jewelry (e.g., bracelet, ring, necklace, anklet, etc.), glasses or goggles, clothing, chest strap, patch, etc. The wearable device 100 of the present disclosure can include a combination of elements for gathering data, analyzing and manipulating data, communicating the data for analysis, and providing information to a user, either directly through the wearable device 100 itself or through another computing device.

Referring to FIG. 1B, an example rear view of the wearable device 100 is depicted. The rear view of the wearable device 100 shows a measurement platform 120 that can automatically measure a plurality of parameters of a person wearing the device. As depicted in FIG. 1B, the wearable 100 can include a measurement platform 120 disposed on an interior portion of the wearable 100, such that it can be positioned on and/or facing the body where subsurface vasculature is easily observable. The measurement platform 120 may house a data collection system including the sensors or other measurement devices 140 for measuring the plurality of parameters. The data collection system can include any combination of components for detecting and/or quantifying any combination of parameters. For example, the measurement platform 120 can have sensors including any one of optical (e.g., CMOS, CCD, photodiode), acoustic (e.g., piezoelectric, piezoceramic), electrochemical (voltage, impedance), thermal, mechanical (e.g., pressure, strain), magnetic, or electromagnetic (e.g., magnetic resonance) sensor. The components of the data collection system may be miniaturized so that the wearable device may be worn on the body without significantly interfering with the wearer's usual activities.

In order to take in vivo measurements in a non-invasive manner from outside of the body, the wearable device may be positioned on a portion of the body where subsurface vasculature is easily observable. The device may be placed in close proximity to the skin or tissue, but need not touch or be in contact therewith. The wearable device 100 can be coupled onto or proximate to a body part using any combination of mechanisms, for example, a strap, clasp, clip, band, fastener, etc. As shown in FIGS. 1A-1C, the wearable device 100 may take the form of a band or strap 110 that can be worn around a part of the body. The strap 110 can be coupled to the wearable device using any combination of methods, such as a clasp, coupling mechanism, adhesive, or a combination thereof.

Continuing with FIGS. 1A and 1B, the wearable device 100 may also include a display 130 providing a graphical user interface through which the wearer of the device may receive information and/or alerts. The information and/or alerts may be generated either from a remote server or other remote computing device, or from a processor within the device. The information and/or alerts could be any indication that can be noticed by the person wearing the wearable device. For example, the information and/or alerts could include a visual component (e.g., textual or graphical information on a display), an auditory component (e.g., an alarm sound), and/or tactile component (e.g., a vibration). The display 130 may also be an input device through which a user can interact with one or more functionalities of the wearable device 100. For example, the display 130 can be a touch screen that the wearer can interact with. For example, the touch screen may be configured to change the text or other information visible on the display 130.

Referring to FIG. 1C, an example of the wearable device 100 being worn by a user, on their wrist, is depicted. The wrist-mounted wearable device 100 shown in FIG. 1C positions the measurement platform 120 on the side of the wearable device 100 that is held against the wearer's wrist while the display 130 is on the opposing side with the strap 110 securing the wearable device 100 to the wrist. While a smart watch is depicted in FIGS. 1A-1C, one of ordinary skill in the art will recognize that any type of wearable device of any design may be provided without departing from the scope of the present disclosure.

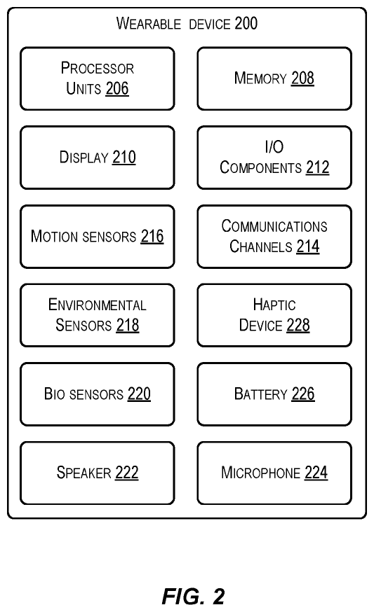

Referring to FIG. 2, FIG. 2 illustrates an example of a wearable device 200 in accordance with the present disclosure. As shown in FIG. 2, the wearable device 200 includes one or more processor units 206 that are configured to access a memory 208 having instructions stored thereon. The processor units 206 of FIG. 2 may be implemented as any electronic device capable of processing, receiving, or transmitting data or instructions. For example, the processor units 206 may include one or more of: a microprocessor, a central processing unit (CPU), graphics processing unit (GPU), tensor processing unit (TPU), an application-specific integrated circuit (ASIC), a digital signal processor (DSP), or combinations of such devices. The processor units 206 may also include special purpose processors, including field-programmable gate arrays (“FPGAs”) or application-specific integrated circuits (“ASICs”) that have been specially configured to perform particular functionality of the present disclosure without separate programming. As described herein, the term “processor” is meant to encompass a single processor or processing unit, multiple processors, multiple processing units, or other suitably configured computing element or elements.

The memory 208 may include removable and/or non-removable elements, both of which are examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory 208 is an example of non-transitory computer storage media. Additional types of computer storage media that may be present in the wearable device 200 may include, but are not limited to, phase-change RAM (PRAM), static random-access memory (SRAM), dynamic random-access memory (DRAM), random-access memory (RAM), read-only memory (ROM), electrically erasable programmable read-only memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the wearable device 200. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

In addition to storing computer-executable instructions, the memory 208 may be configured to store raw data or lightly-processed sensor data and annotations associated with the sensor data. In some examples, the annotations may be produced by the wearable device 200 by executing one or more instructions stored on the memory 208, such as instructions for processing, via a machine-learning algorithm, sensor data to produce annotations associated with the sensor data. Machine-learning techniques may be applied based on training data sets from clinical data or other data established as truth, such as from data entered by clinicians associated with a VME. The stored sensor data, annotations, or other such data may be stored at the memory 208 or at a remote server, for example communicated across network 204.

The instructions or computer programs may be configured to perform one or more of the operations or functions described with respect to the wearable device 200. For example, the instructions may be configured to control or coordinate the operation of the various components of the device. Such components include, but are not limited to, display 210, one or more input/output (I/O) components 212, one or more communication channels 214, one or more motion sensors 216, one or more environmental sensors 218, one or more biosensors 220, a speaker 222, microphone 224, a battery 226, and/or one or more haptic devices 228.

The display 210 may be configured to display information via one or more graphical user interfaces and may also function as an input component, e.g., as a touchscreen. Messages relating to operations or functions described with respect to the wearable device 200 may be presented at the display 210 using the processor units 206.

The I/O components 212 may include a touchscreen display, as described, and may also include one or more physical buttons, knobs, and the like disposed at any suitable location with respect to a bezel of the wearable device 200. In some examples, the I/O components 212 may be located on a band of the wearable device 200.

The communication channels 214 may include one or more antennas, one or more network radios, and/or one or more radio transceivers (or transmitter or receiver) to enable communication between the wearable device 200 and other electronic devices such as external sensors, other electronic devices such as a smartphone or tablet, other wearable electronic devices, external computing systems such as a desktop computer or network-connected server. In some examples, the communication channels 214 may enable the wearable device 200 to pair with a primary device such as a smartphone or other computing device. The pairing may be via Bluetooth or Bluetooth Low Energy (BLE), near-field communication (NFC), or other suitable network protocol, and may enable some persistent data sharing. For example, data from the wearable device 200 may be streamed and/or shared periodically with another device, and the other device may process the data and/or share with a server or cloud environment for additional processing. In some examples, the wearable device 200 may be configured to communicate directly with the server or cloud environment via any suitable network, e.g., the Internet, a cellular network, etc.

The sensors of the wearable device 200 may be generally organized into three categories including motion sensors 216, environmental sensors 218, and biosensors 220, though other sensors or different types or categories of sensors may be included in the wearable device 200. As described herein, reference to “a sensor” or “sensors” may include one or more sensors, devices, circuits, etc. from any one and/or more than one of the three categories including those of which that may not fit into one of the categories. In some examples, the sensors may be implemented as hardware, firmware, and/or in software.

Generally, the motion sensors 216 may be configured to measure acceleration and rotation along one or more axes. Examples of motion sensors include accelerometers, gravity sensors, gyroscopes, rotational vector sensors, significant motion sensors, step counter sensor, Global Positioning System (GPS) sensors, and/or any other suitable sensors. In some embodiments, the wearable device 200 can include an inertial measurement unit (IMU) sensor for measuring angular rate, force and sometimes magnetic field. Motion sensors may be useful for monitoring device movement, such as tilt, shake, rotation, or swing. The movement may be a reflection of direct user input (for example, a user steering a car in a game or a user controlling a ball in a game), but it can also be a reflection of the physical environment in which the device is sitting (for example, moving with a driver in a car). In the first case, the motion sensors may monitor motion relative to the device's frame of reference or your application's frame of reference; in the second case the motion sensors may monitor motion relative to the world's frame of reference. Motion sensors by themselves are not typically used to monitor device position, but they can be used with other sensors, such as the geomagnetic field sensor, to determine a device's position relative to the world's frame of reference. The motion sensors 216 may return multi-dimensional arrays of sensor values for each event when the sensor is active. For example, during a single sensor event the accelerometer may return acceleration force data for the three coordinate axes, and the gyroscope may return rate of rotation data for the three coordinate axes.

Generally, the environmental sensors 218 may be configured to measure environmental parameters such as temperature and pressure, illumination, and humidity. The environmental sensors 218 may also be configured to measure the physical position of the device. Examples of environmental sensors 218 may include barometers, photometers, thermometers, orientation sensors, magnetometers, Global Positioning System (GPS) sensors, and any other suitable sensor. The environmental sensors 218 may be used to monitor relative ambient humidity, illuminance, ambient pressure, and ambient temperature near the wearable device 200. In some examples, the environmental sensors 218 may return a multi-dimensional array of sensor values for each sensor event or may return a single sensor value for each data event. For example, the temperature in ° C. or the pressure in hPa. Also, unlike motion sensors 216 and biosensors 220, which may require high-pass or low-pass filtering, the environmental sensors 218 may not typically require any data filtering or data processing.

The environmental sensors 218 may also be useful for determining a device's physical position in the world's frame of reference. For example, a geomagnetic field sensor may be used in combination with an accelerometer to determine the user device's 202 position relative to the magnetic north pole. These sensors may also be used to determine the user device's 202 orientation in some of frame of reference (e.g., within a software application). The geomagnetic field sensor and accelerometer may return multi-dimensional arrays of sensor values for each sensor event. For example, the geomagnetic field sensor may provide geomagnetic field strength values for each of the three coordinate axes during a single sensor event. Likewise, the accelerometer sensor may measure the acceleration applied to the wearable device 200 during a sensor event. The proximity sensor may provide a single value for each sensor event.

Generally, the biosensors 220 may be configured to measure biosensor signals of a wearer of the wearable device 200 such as, for example, heart rate, blood oxygen levels, perspiration, skin temperature, etc. Examples of biosensors 220 may include a heart rate sensor (e.g., photoplethysmography (PPG) sensor, electrocardiogram (ECG) sensor, electroencephalography (EEG) sensor, etc.), pulse oximeter, moisture sensor, thermometer, and any other suitable sensor. The biosensors 220 may return multi-dimensional arrays of sensor values and/or may return single values, depending on the sensor. While FIG. 2 only depicts the biosensors 220 as including a single element, any suitable number of biosensors may be included within the wearable device 200. The biosensors 220 may also include remote sensors located at different locations on a human user. For example, the user can be wearing one or more position sensors, remote to the wearable device 200, that may be used to track positional location of body parts (e.g., hands, arms, legs, feet, head, torso, etc.).

Continuing with FIG. 2, the acoustical elements, e.g., the speaker 222 and the microphone 224 may share a port in housing of the wearable device 200 or may include dedicated ports. The speaker 222 may include drive electronics or circuitry and may be configured to produce an audible sound or acoustic signal in response to a command or input. Similarly, the microphone 224 may also include drive electronics or circuitry and is configured to receive an audible sound or acoustic signal in response to a command or input. The speaker 222 and the microphone 224 may be acoustically coupled to a port or opening in the case that allows acoustic energy to pass, but may prevent the ingress of liquid and other debris.

The battery 226 may include any suitable device to provide power to the wearable device 200. In some examples, the battery 226 may be rechargeable or may be single use. In some examples, the battery 226 may be configured for contactless (e.g., over the air) charging or near-field charging.

The haptic device 228 may be configured to provide haptic feedback to a wearer of the wearable device 200. For example, alerts, instructions, and the like may be conveyed to the wearer using the speaker 222, the display 210, and/or the haptic device 228.

Each of the components discussed with respect to FIG. 2 may be positioned within a hermetically sealed housing, though in some components, such as the biosensors 220, may include elements that are positioned on the outside of the housing or that protrude through the housing. In addition, an antenna for the communications channel 214 may be formed inside or outside the housing and, in some examples, may be formed on the housing, whether on an inner or outer surface (or a combination of both).

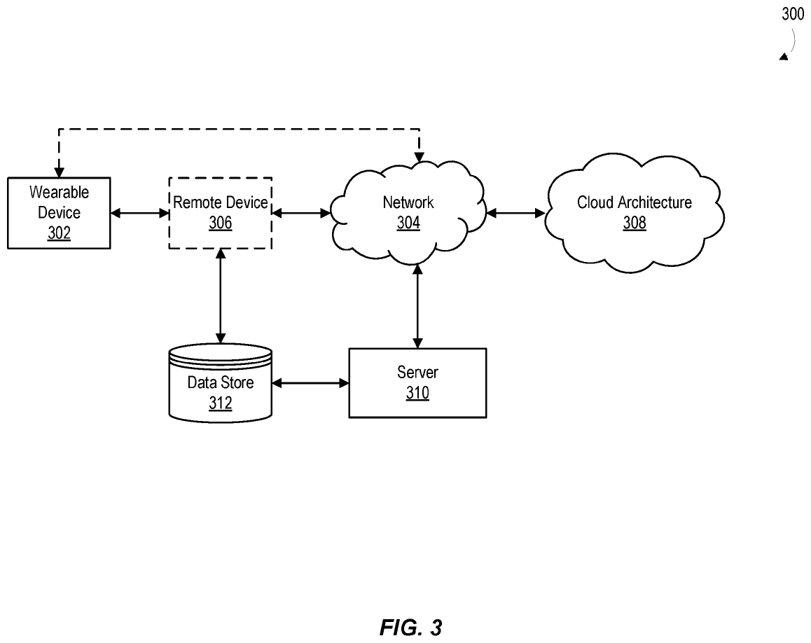

Referring now to FIG. 3, FIG. 3 illustrates a system 300 including one or more wearable devices 302 with on-body detection. The one or more wearable devices 302 may be configured to communicate with and exchange data with one or more other devices over a communication medium 304. The wearable device 302 may intermittently be in communication with other devices for delivering and receiving data. For example, the wearable device 302 may be enabled to transfer data (e.g., raw data or lightly-processed sensor data, annotation data, adjustment information, user input data) which can be used by other devices or services for storing the data, recording historical data, performing analysis on data, storing the data, etc.

The communication medium 304 may include any means for the transfer of data, including both wired and wireless communications. For example, the wearable device 302 may configured to transfer and receive data using any suitable wired or wireless communication mechanism, including Ethernet, Thunderbolt, Universal Serial Bus (“USB”), Bluetooth, BLE, any available 802.11 protocol, WI-FI, any suitable mesh networking protocol (e.g., 802.15.4, etc.), any cellular protocol (e.g., 4G, LTE, 5G, etc.), near-field communication (“NFC”), etc.

Such communications may be through one or more intermediary networks, including any number of local area networks (“LANs”), wide area networks (“WANs”), metro-area networks (“MANs”), the Internet, etc. The wearable devices 302 may use the communication medium 304 to communicate with other devices, for example, to perform additional computation on the data collected by the wearable devices 302.

The system 300 may include a combination of other devices that interact with the one or more wearable devices 302 and/or utilize the data provided by the one or more wearable devices 302. The other devices can include any combination of remote devices 306, cloud architectures 308, servers 310, data stores 312, etc. Each of the remote devices 306, cloud architectures 308, servers 310, data stores 312, etc. may be configured to communicate data over the communication medium 304. In some instances, the remote devices 306 can be an optional device acting as an intermediary device (e.g., laptop, computer, cradle, charging dock, etc.) between a wearable device 302 and one of the cloud architectures 308, servers 310, data stores 312, etc. For example, the wearable device 302 and the remote devices 306 may be configured for low-powered, short-range communications, such as, communications using a Bluetooth ® protocol and/or a ZigBee® protocol and the remote devices 306 can process and/or relay the information over the communication medium 304. Thus, the wearable device 302 can transmit data to the intermediary remote device 106, such as, but not limited to, smart phones, laptop computers, desktop computers, and tablet computers, which in turn transmit the data to the cloud architectures 308 or servers 310. Alternatively, the wearable device 302 can upload data directly to one or more of the cloud architectures 308, servers 310, data stores 312, etc. upon establishing a connection to the Internet or to one of the cloud architectures 308, servers 310, data stores 312, etc.

The remote devices 306, cloud architectures 308, servers 310, data stores 312, etc. can include a single computing device, a collection of computing devices in a network computing system, a cloud computing infrastructure, or a combination thereof. Similarly, the data store 312 can include any combination of computing devices configured to store and organize a collection of data. For example, data store 312 can be a local storage device on the remote device 306, a remote database facility, or a cloud computing storage environment. The data store 312 can also include a database management system utilizing a given database model configured to interact with a user for analyzing the database data.

In addition to receiving communications from the wearable device 302, including biosensor data, the remote devices 306, cloud architectures 308, servers 310, data stores 312, etc. may also be configured to gather and/or receive either from the wearable device 302 or from some other sources, information regarding a wearer and other wearers. Information can include user information, health information, environmental factors, geographical data, etc. For example, a user account may be established on the server 310 or cloud architecture 308 for every wearer that contains the wearer's biosensor data. The data collected by the wearable device 302 can be processed by the wearable device 302 itself, on one or more of the remote devices 306, cloud architectures 308, servers 310, data stores 312, or a combination thereof. When providing data to the remote devices 306, cloud architectures 308, servers 310, data stores 312, for processing, it may reduce a computational load on the wearable device 302 which may in turn enable the use of less sophisticated computing devices and systems built into the wearable device 302.

Further, some embodiments of the system 300 may include privacy controls which may be automatically implemented or controlled by the wearer of the wearable device 302. For example, where a wearer's collected physiological parameter data and biosensor data are uploaded to the remote devices 306, cloud architectures 308, servers 310, data stores 312, etc. for analysis, the data may be treated in one or more ways before it is stored or used, so that personally identifiable information is removed. For example, a wearer's (or user's) identity may be treated so that no personally identifiable information can be determined for the user, or a user's geographic location may be generalized where location information is obtained (such as to a city, ZIP code, or state level), so that a particular location of a user cannot be determined.

Additionally or alternatively, wearers of a wearable device 302 may be provided with an opportunity to control whether or how the wearable device 302 collects information about the wearer (e.g., biosensor data, location data, user preferences, etc.), or to control how such information may be used. Thus, the wearer of the wearable device 302 may have control over how information is collected about him or her and used by other users of the data. For example, a wearer may elect that data, such as biosensor data, collected from his or her wearable device 302 may only be used for collection and comparison of his or her own data and may not be used for other purposes.

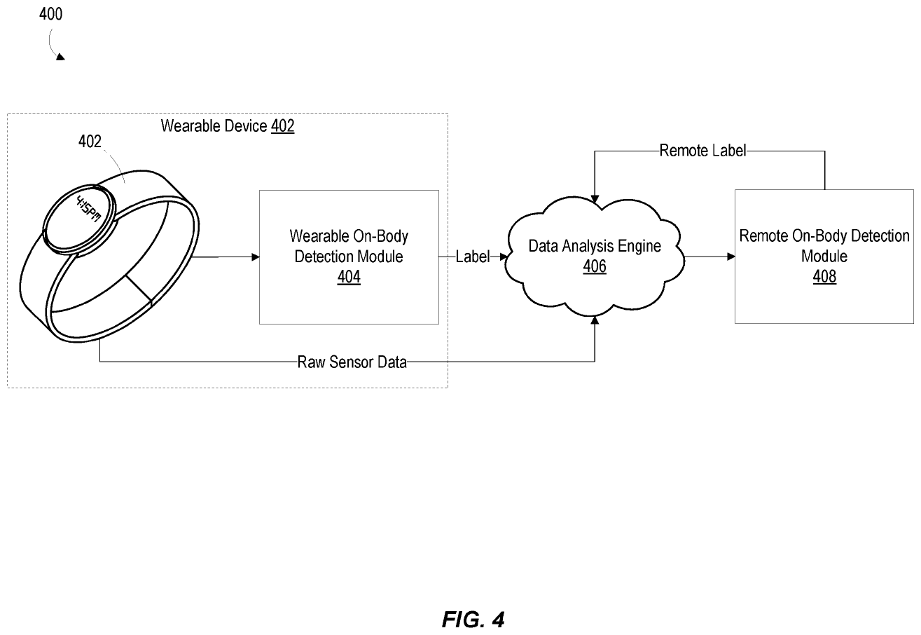

Referring to FIG. 4, FIG. 4 illustrates an example of a schematic diagram of an architecture 400 for on-body detection for a wearable device 402, in accordance with the present disclosure. The architecture 400 can be used to determine when a participant is wearing or not wearing a wearable device. Specifically, the architecture 400 is designed such that a highly accurate determination can be made when a wearable device is being worn or not worn. The architecture can include a wearable device 402, a wearable on-body detection module 404, a data analysis engine 406, and a remote on-body detection module 408. The wearable device 402 can include any combination of wearable devices, such as the wearable devices 100, 200, 302 discussed with respect to FIGS. 1A-3.

As shown in FIG. 4, the wearable device 402 can provide input data (e.g., raw data or lightly-processed sensor data) to a combination of components within the architecture 400 for additional processing. For example, the wearable device 402 can provide a first input to the wearable on-body detection module 404 and a second input to the data analysis engine 406. The first input and second input can include different data, the same data, or a combination thereof. For example, the wearable device 402 can provide a first set of sensor data (e.g., EDA sensor data) to the wearable on-body detection module 404 and a second set of sensor data, including the first set of sensor data and additional sensor data (Photoplethysmography (PPG) sensor data, Inertial Measurement Unit (IMU) sensor data, and Electrocardiogram (ECG) sensor data), to the remote on-body detection module 408. The components receiving and processing the first input (wearable on-body detection module 404) and the second input (data analysis engine 406 and remote on-body detection module 408) can be separate devices with the first input being processed by the wearable device 402 itself.

As would be appreciated by one skilled in the art, the on-body detection module 404, the data analysis engine 406, and the remote on-body detection module 408 can include any combination of hardware and software configured to carry out the various aspects of the present invention. Additionally, each of on-body detection module 404 and the remote on-body detection module 408 may be part of different devices and can be configured to use a different combination of data and steps to determine whether a wearable device 402 is located on a body of a wearer and adjusting biosensor sensors based on that determination.

The on-body detection module 404 can be included within the wearable device 402 itself and can be configured to make a determination whether the wearable device 402 is currently being worn by a user (e.g., on-body). For example, the on-body detection module 404 can be implemented within the firmware (e.g., an embedded processor) of the wearable device 402 and can be configured to perform a first process on data collected by one or more of the available the biosensors (e.g., biosensor 220) within the wearable device 402. The first process can use any combination data collected by the biosensors on the wearable device 402 to make a determination whether the wearable device 402 is currently being worn. To save processing power and memory usage on the wearable device 402, only a subset of the available biosensors can be utilized with the first process. The subset of biosensor data can be a single sensor or a combination of select sensors. In one example, an electrodermal activity (EDA) sensor can be used to provide an input into the first process for the on-body detection module 404. The on-body detection module 404 can use the input to determine whether the input value(s) meets certain threshold criteria and thus determine whether the wearable device 402 is currently being worn by a user, as discussed in greater detail herein.

The on-body detection module 404 can use thresholds that have high sensitivity such that it is designed to ensure that most, if not all, on-body events (times that the wearable device 402 is being worn by a user) are identified, even if that means that off-body events (times that the wearable device 402 is not being worn by a user) are incorrectly identified as on-body events. Thereafter, the on-body detection module 404 can take subsequent actions depending on the on-body or off-body determinations. The subsequent actions can include activating a full set of sensors, if the device is detected to be on-body, as well as saving and sharing raw data or lightly-processed data sensor data from the subset biosensors and the labeled determinations for additional processing. Alternatively, if the determination is that the wearable device 402 is off-body, the actions can be to disable all but a subset of sensors used to obtain data to perform the on-body detection. The raw data or lightly-processed sensor data and the labels can be provided to the same or different destinations within the architecture 400. For example, as shown in FIG. 4, the labeled determinations and the raw data or lightly-processed sensor data are provided to the data analysis engine 406. Thereafter, the received data can be processed and/or shared with other devices for processing. For example, the data analysis engine 406 can save the received label data, the raw data or lightly-processed signal data, and provide a copy of the raw data or lightly-processed signal data to the remote on-body detection module 408 for further processing.

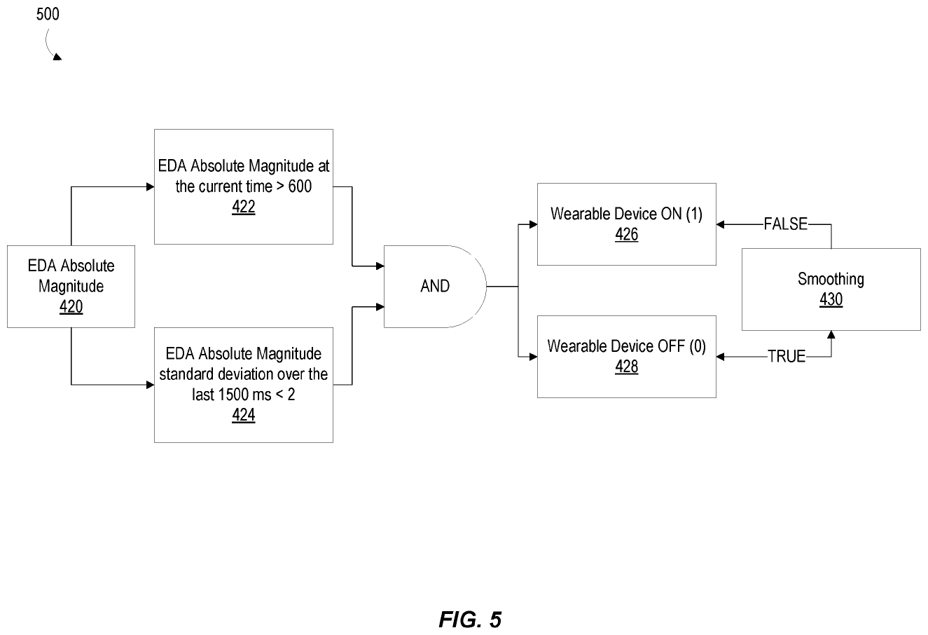

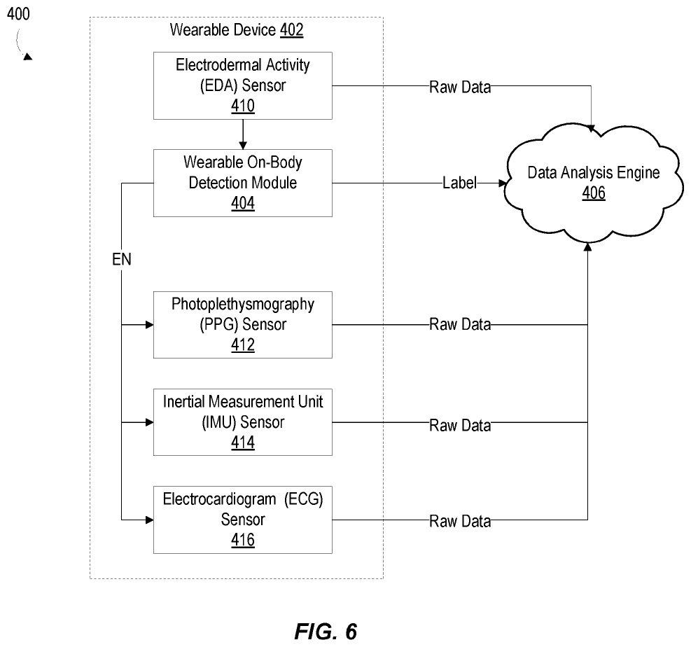

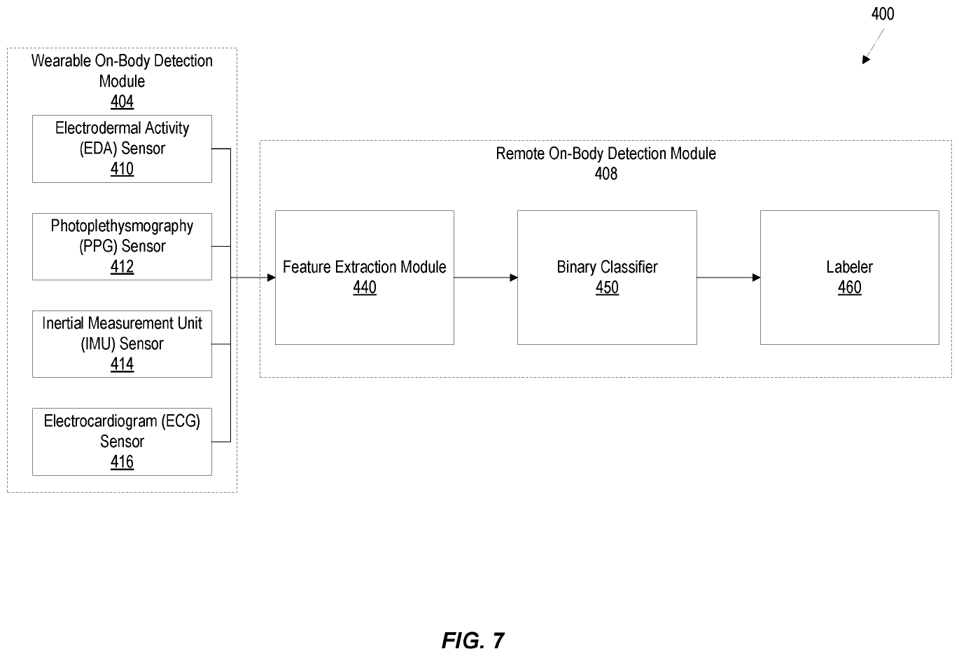

The details of the wearable on-body detection module 404 and the remote on-body detection module 408 are described below with respect to FIGS. 5 and 6, which relate to the wearable detection module 404, and FIG. 7, which relates to the remote on-body detection module 408.

Referring to FIG. 5, FIG. 5 illustrates a diagram showing an example operation of the on-body detection module 404, in accordance with the present disclosure. Specifically, FIG. 5 shows the process 500 performed by the on-body detection module 404 to determine the labels to be output by the wearable device 402. Initially, the on-body detection module 404 receives real time data inputs from one or more of the biosensors within the wearable device 402. The one or more biosensors should be a subset of the totality of biosensors available on the wearable device 402 and are specifically selected to save some combination of processing power, memory usage, battery usage, etc. For example, IMU sensors, PPG sensors, ECG sensors, etc. may consume large amounts of power. Thus, the subset of sensors may include the EDA sensor, which only requires a small amount of power, and may not include other sensors, such as the IMU, PPG, ECG. Although the present disclosure discusses the on-body detection module 404 using of the EDA sensor as the subset of the available sensors, any combination of sensors (IMU, PPG, ECG, etc.) can be used as part of the subset of sensors by the on-body detection module 404 without departing from the scope of the present disclosure. For example, the IMU sensor could be used as the subset of sensors instead of the EDA sensor and the EDA sensor could be included as part of the other available sensors.

The example depicted in FIG. 5 uses signal data from an EDA sensor. An EDA sensor may be capable of accurately measuring changes in heart rate and the electrical properties of the skin. For example, by measuring impedance or resistance between a plurality of electrodes (on the skin) the sensor can detect changes that are caused by alterations in sweat secretion and sweat gland activity. An EDA sensor can output an absolute magnitude value (step 420) that is used as the input for the process 500. The absolute magnitude value can be an analog to digital count that is a function of skin impedance at a certain frequency. Although any combination of output data from the EDA sensor (or other sensors) could be used, for example, the process 500 could use mean imaginary value (Q), mean real value (I), mean magnitude value, standard deviation for imaginary value (Q), standard deviation for real value (I), standard deviation for magnitude value, phase, etc. The Q and I values can be determined by circuitry that directly provides the real and imaginary components of (complex-valued) impedance at a certain frequency by performing modulations. There can be some initial processing of the signal for simplification prior to identifying the target values. For example, the on-body detection module 404 can apply a high frequency sine wave to a raw data or lightly-processed signal and demodulate that signal to create a low frequency signal that includes real and imaginary components that provide sampling estimates of real and imaginary components of the signal. Thereafter, features extraction steps can be performed to determine an EDA absolute magnitude value at a current time and calculate a standard deviation for the EDA absolute magnitude value over a preceding predetermine period of time. Regardless of the value(s) being measured, the on-body detection module 404 can continuously sample the values. For example, the on-body detection module 404 can continuously sample the EDA absolute magnitude at 10 Hz/100 ms, in real time, which would not be overly processor or memory intensive.

Based on the extracted values, a binary classification or threshold determination can be made. As shown in FIG. 5, the threshold determination can be determining whether the EDA absolute magnitude value at the current time is greater than a predetermined value (e.g., count of 600-800) (step 422) and determining whether the standard deviation for the EDA absolute magnitude value, over the last predetermined period of time (e.g., 1500 ms) (step 424), is below a given threshold value (e.g., less than 2). The predetermined value (e.g., 600-800) should be set such that it captures almost all on-body indications with the occasional false off-body indication. For example, if on-body indications are usually in the range of 150-250 and off in the range of 800-1300, then a value of 600-800 can be set to ensure an overgenerous capture of almost all (e.g., 99%+) of on-body events. This process can be performed to classify a single data point or an aggregation window (e.g., average of at least 15 samples) can be used to prevent switching states too often. If using an aggregation window, then the states can be determined based on a rolling average less than or greater than 1.

Based on the results of these determinations, the process will output a label for whether the device is on-body (“On”) or off-body (“Off”). The labels can be determined using any combination of hardware or software logic. For example, as shown in FIG. 5, an AND gate logic or hardware can be used to output a ‘1’ (if both determinations are TRUE) or ‘0’ (if one or less of the determinations are TRUE). If the output is ‘1’ then it has been determined that the wearable device is labeled as “On” (step 426) and if it is ‘0’ then it has been determined that the wearable device is labeled as “Off” (step 428). This is advantageous because, although the wearable device may be storing real time data continuously for the subset (or first set) of sensors (e.g., EDA), the raw data or lightly-processed data for all the other sensors (or second set) does not need to be stored unless the wearable device is labeled as “On”. As such, the amount of data that is being stored in memory and amount of processing that needs to be performed by the wearable device is still greatly reduced.

The process 500 can include an additional or optional step of smoothing out the data to increase the accuracy of the “On/Off” prediction (step 430). The smoothing step can include checking the mean label value is zero over a predetermined period of time (e.g., 1500 ms) and remove spurious “Off” labels as part of a loop with steps 426 and 428. If the mean is not zero over the predetermined period of time, then the smoothing step will return a FALSE indication to instruct an “On” labeling, otherwise if TRUE, then the smoothing step will provide an instruction for an “Off” labeling. Thereafter, the final labeling (body-on or body-off) can be output, for example, to the data analysis engine 406. Depending on the labeling, the on-body detection module 404 may also perform additional steps.

Referring to FIG. 6, FIG. 6 illustrates a diagram showing an example operation of the on-body detection module 404 to enable or disable other sensors on the wearable device 402, based on the labels from FIG. 5. Specifically, FIG. 6 provides an example of how the on-body detection module 404 may enable additional sensors on the wearable device 402 in response to a determination that the wearable device 402 is on-body, based on data received from an always on subset of the sensors. In the example in FIG. 6, the EDA sensor 410 is the subset sensor providing the input into the on-body detection module 404 for the on-body/off-body determination. Initially, the EDA sensor 410 may continuously provide its data (e.g., EDA absolute magnitude) while the other sensors (photoplethysmography (PPG), inertial measurement unit (IMU), and Electrocardiogram (ECG) sensors) are powered down or off. Thereafter, depending on the labels being output (e.g., via process 500 in FIG. 5) by the on-body detection module 404, the other sensors will remain powered down or be powered on to read and report data. Specifically, when the determination is ON then the other sensors will be activated, when the determination is OFF the other sensors will remain deactivated (or will be deactivated if they are currently active). The power state of the sensors can be controlled using any combination of mechanisms. For example, the on-body detection module 404 may have an enable (EN) output when the determination is ON and will enable each of the remaining sensors, as depicted in FIG. 6. Similarly, the activating/deactivating sensors could be performed in hardware, software, or a combination thereof.

When sensors are activated, then they can start gathering data and transmitting the data. Although FIG. 6 shows the data being transmitted directly from the sensors 412, 414, 416 to the data analysis engine 406, the data can be saved within memory of the wearable device 402 prior to being transmitted to the data analysis engine 406. Similarly, instead of being provided to the data analysis engine 406 and then relayed to the remote on-body detection module 408, the raw data or lightly-processed signal data can also be provided directly to the remote on-body detection module 408 (in addition to or in place of the data analysis engine 406). Since the sensors 412, 414, 416 are limited to being powered when the on-body detection module 404 determines that the wearable device 402 is being worn (even if this is incorrectly determined on occasion), the wearable device 402 is able to save on battery power, processing resources, and memory capacity. Similarly, since the data is limited to collection during operation of the sensors, the data can be saved as raw data or lightly-processed signal data, which may be more useful in downstream analysis (e.g., by data analysis engine 406 and remote on-body detection module 408). The raw data or lightly-processed signal data can be collected by the wearable device 402 until the wearable device 402 is ready to download the data to another device within the system 400. For example, once the wearable device 402 connects to a network (e.g., wired, wireless, etc.) or syncs it can establish a connection with another device within the system 400 and share all the stored data. The other devices within the system can receive and process the data accordingly. For example, the remote on-body detection module 408 can receive all of the raw data or lightly-processed signal data and process it to make its own determination as to whether the wearable device 402 was being worn when that data was collected.

Referring to FIG. 7, FIG. 7 illustrates a diagram showing an example operation of the remote on-body detection module 408. The remote on-body detection module 408 can be a device or system that is separate and/or remote from the wearable device 402 which has greater computational resources to perform more complex analyses. For example, the remote on-body detection module 408 can be part of a remote server (e.g., server 310), remote device (e.g., remote device 306), a remote cloud architecture (e.g., cloud 308), or a combination thereof. The remote on-body detection module 408 can include a second process, independent of the wearable on-body detection module 404, for determining whether a wearable device 402 is being worn using a larger collection of sensor data. The output of the second process can then be provided to the data analysis engine 406 as a check against the output (or superseding the output) of the first process performed by the on-body detection module 404. The process performed by the remote on-body detection module 408 can be independent from the process performed by the on-body detection module 404 such that the remote on-body detection module 408 is unaware or unconcerned with the results of the on-body detection module 404. In other words, the remote on-body detection module 408 may not receive the labels produced by the on-body detection module 404 but only receives the raw data or lightly-processed data relayed by the data analysis engine 406.

The second process can use any combination of data available from all of the raw data or lightly-processed data received from the wearable device 402 and is not limited just to the subset of data relied upon by the wearable on-body detection module 404 when making its determination. For example, the remote on-body detection module 408 can include a feature extraction module 440 that receives raw data or lightly-processed signal data from the EDA 410, the PPG 412, the IMU 414, and the ECG 416 sensors, or any other sensors on the wearable device 402, which can be used in combination to make an on-body determination. While this example lists the sensors 410, 412, 414, 416, any combination of sensors could be relied upon without departing from the scope of the present disclosure.

The feature extraction module 440 can extract any combination of measurements, values, metrics, etc. from the received raw data or lightly-processed signal data from any combination of the sensors. Thereafter, the feature extraction module 440 can provide the extracted data to a binary classifier 450 to perform one or more operations on the data. The binary classifier 450 can include any combination of functions or calculations, such as for example, random force classification, naïve bayes, logistic regression, k-nearest neighbors, support vector machine, decision tree, random forest, voting classification, neural network, etc. to determine whether the signal data indicates that the wearable device 402 was being worn. Based on the determination by the binary classifier 450, the labeler 460 can provide the on-body (“On”) or off-body (“Off”) labels to the data analysis engine 406. The labeling process can be a similar process to the labeling discussed with respect to the wearable on-body detection module 404.

Returning again to FIG. 4, in addition to receiving the raw data or lightly-processed signal data from the wearable device 402, the data analysis engine 406 can receive on-body (“On”) and off-body (“Off”) labels from each of the wearable on-body detection module 404 and the remote on-body detection module 408. The data analysis engine 406 can be included on a device or system that is separate from the wearable device 402 which has greater computational resources to perform more complex analyses. For example, the data analysis engine 406 can be part of a remote server (e.g., server 310), remote device (e.g., remote device 306), a remote cloud architecture (e.g., cloud 308), or a combination thereof. The data analysis engine 406 can be the same or different device(s) as the remote on-body detection module 408. All of the raw data or lightly-processed signal data and labels can be stored by the data analysis engine 406 and additional processing can be performed.

The additional processing by the data analysis engine 406 can include comparing the on-body (“On”) and off-body (“Off”) labels from each of the wearable on-body detection module 404 and the remote on-body detection module 408 for each period of time. The comparison may include checking to see if the labels are the same or different, for example are both labels “On” or “Off”. If the labels match or are the same, then the labels are accepted and stored as correct. If the labels do not match or are not the same, then the label received from the remote on-body detection module 408 is accepted as the correct label. Alternatively, the data analysis engine 406 can store each of the results from the on-body detection module 404 and the remote on-body detection module 408 but only use the results provided by the remote on-body detection module 408 when providing data to downstream applications, such that no comparison is needed. Regardless, the remote on-body detection module 408 should provide labels that are given priority to the labels from the wearable on-body detection module 404 because the wearable on-body detection module 404 is intentionally designed for simplicity to be overinclusive (i.e., it is designed to generate false positives, but avoid false negatives) while the remote on-body detection module 408 is designed to leverage greater computational resources for specificity (try to be as accurate as possible when ON or OFF). As such, the data analysis engine 406 is designed to eliminate the false detections that may have been captured by the wearable on-body detection module 404. Once the correct labels are determined, then the raw data or lightly-processed data and the correct labels can be provided for use by downstream applications, compliance reports for subjects (e.g., a subject was wearing the wearable device 402 when they were supposed to be), etc.

The data analysis engine 406 may also convey data back to one or both of the on-body detection module 404 and the remote on-body detection module 408. The data could be provided for a variety of purposes including improving the future operation of the respective devices. For example, the results of the remote on-body detection module 408 could be provided to the on-body detection module 404 to retrain and improve operation of the on-body detection module 404.

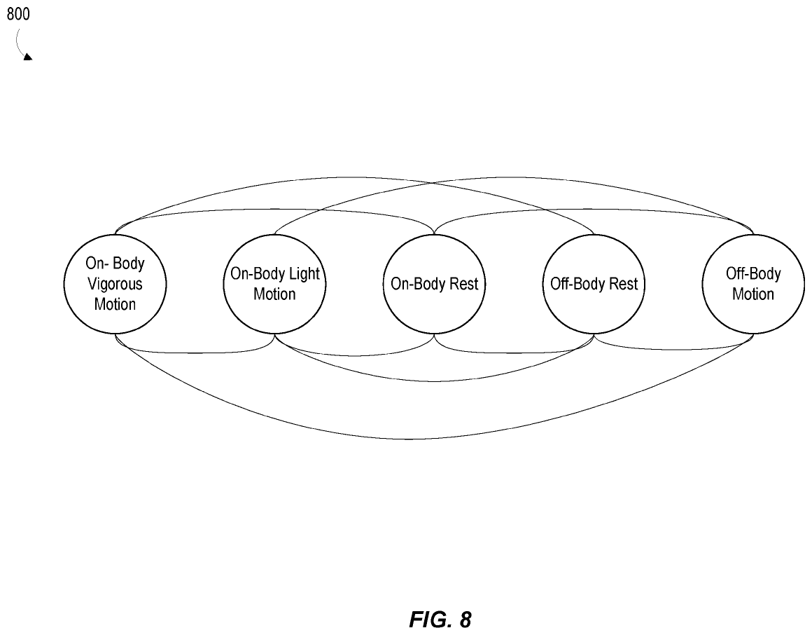

Referring to FIG. 8, FIG. 8 illustrates a diagram showing an example operation of data analysis engine 406. Specifically, FIG. 8 depicts the different classifications for the on-body and off-body states that can be determined by the data analysis engine 406. Being able to identify more specific classes other than just ON or OFF, the data analysis engine 406 can provide more accurate determinations of user activity. The classification labels can include any number of activity classifications reflecting how the wearable device 402 is or is not moving when it is on-body or off-body. For example, as shown in FIG. 8, the classification labels can include “on-body vigorous motion”, “on-body light motion”, “on-body rest”, “off-body rest”, and “off-body motion”.

The states provided in FIG. 8 depict possible transitions between states in which the data analysis engine 406 can use in making temporal individual window determinations for the ON or OFF states of the wearable device 402. The temporal individual window determinations can include calculating probability classification labels for different ON and OFF states as well as transitions between those states. In other words, the data analysis engine 406 can be configured to make successive estimations based on the previous states and historical trends related to those states previously. The estimations of a current state can be based off the history and current readings from the EDA, IMU, PPG, etc. sensors. For example, a high reading from the IMU sensor may indicate a higher level of motion. The historical data can also be used to predict the transition probabilities between the states. For example, based on historical data related to on-body rest and subsequent states associated with on-body rest, it is unlikely that the next one will be off-body motion. Therefore, in this example, the data analysis engine 406 may determine that it is more likely that the state should be on-body motion.

The data analysis engine 406 can use previous states in previous temporal windows to make more accurate determinations. For example, the data analysis engine 406 can implement a hidden Markov model to make vector observations based on the sensor outputs. The hidden Markov model can use previous raw or lightly processed signal data-based states to make predictions about the most likely sequence of states (rather than estimating a current state) which can then be used to define many different states instead of just on-body or off-body states. This can also be used to account for mislabeling, for example, if a wearable device 402 is off-body but moving (e.g., during transport) it may have been incorrectly labeled as on-body.

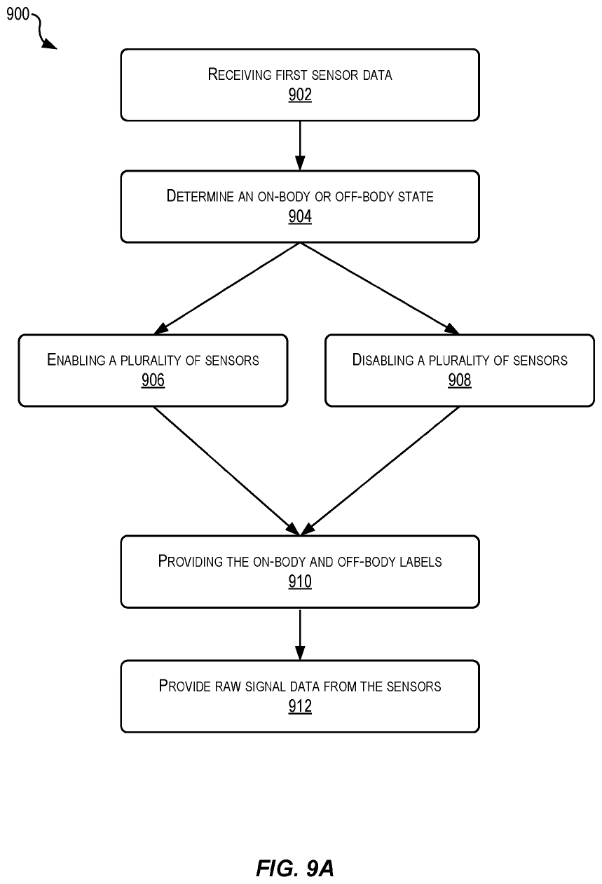

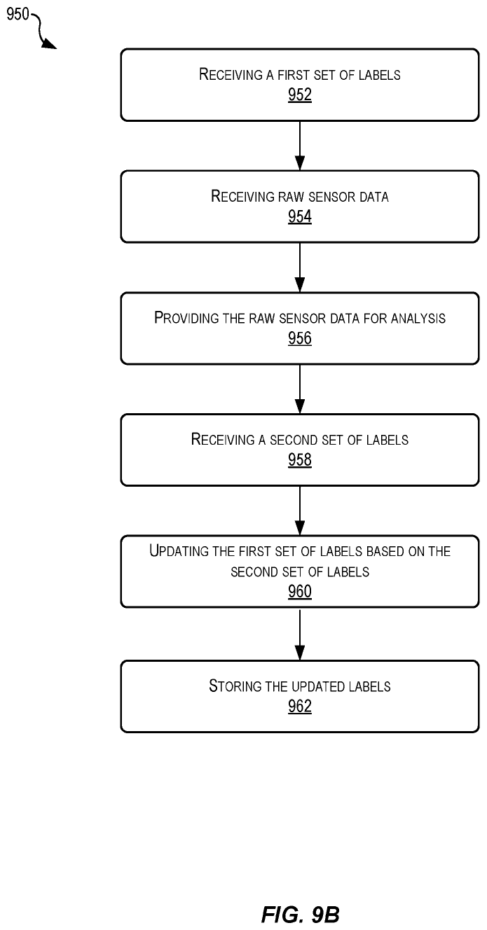

Referring now to FIG. 9A, FIG. 9A shows an example process performed by a wearable device to predict or determine an on-body status of the wearable device. At step 902 the wearable device receives signal data from a subset (or first set) of biosensors of a plurality of biosensors in a wearable device. For example, the wearable device can receive a continuous signal from an EDA sensor. At step 904 the wearable device determines an on-body or an off-body state of the wearable device based on the signal data. For example, the wearable device executes the process discussed with respect to FIG. 4.

At step 906 the wearable device enables the remaining (or second set) of the plurality of biosensors, when the on-body status is determined to be the on-body state, to record raw data or lightly-processed signal data from the remaining plurality of biosensors (including the EDA sensor data). For example, the wearable device executes the process discussed with respect to FIG. 5 to enable the other sensors (e.g., PPG, IMU, ECG) available to the wearable device. At step 908 the wearable device disables the other biosensors (e.g., the sensors other than the always on subset of sensors), when the on-body status is determined to be the off-body state, to stop recording raw data or lightly-processed signal data from the other of biosensors. For example, the wearable device executes the process discussed with respect to FIG. 5 to disable the other sensors (e.g., PPG, IMU, ECG), while the subset (e.g., EDA) remains active for continuing on-body determinations.

At step 910 the wearable device provides the on-body state or the off-body state to a data analysis engine, for example, the wearable device executes the process discussed with respect to FIG. 4. The wearable device can provide data in using any combination of methods. For example, the wearable device can provide the data in clusters with associated timestamps and sampling rates that enable the data to be unpacked later (e.g., by data analysis engine 406 and/or remote on-body detection module 408). For example, EDA data can be sampled at 10 Hz and grouped in buffers/clusters that are roughly 3 seconds apart and each one having ~30 samples.

At step 912 the wearable device provides the recorded raw data or lightly-processed signal data from the plurality of biosensors (the subset and the other sensors) to the data analysis engine, for example, the wearable device executes the process discussed with respect to FIG. 4. The data provided by the wearable device should be sufficient for the remote determination to process it with high accuracy.

Referring now to FIG. 9B, FIG. 9B shows an example process performed by a remote device to predict or determine an on-body status of the wearable device. At step 952 the remote device receives one or more high sensitivity on or off labels from an on-body detection module on a wearable device. For example, the remote device can receive one or more high sensitivity on or off labels from the wearable device, the labels being based on the on-body determination made by the wearable device. At step 954 the remote device receives raw data or lightly-processed sensor data for one or more biosensors on the wearable device, for example, as discussed with respect to FIGS. 4 and 6. At step 956 the remote device provides the raw data or lightly-processed sensor data to a remote on-body detection module separate from the wearable device, for example, as discussed with respect to FIG. 4. The remote on-body detection module can be part of the remote device or a separate remote device.

The remote on-body detection module can perform its own on-body and off-body determines based on the raw data or lightly-processed sensor data. The remote on-body detection module can use a combination of determinations based on the data being provided by the different sensors. For example, a high SNR (ratio of power in the physiological frequency band of interest, i.e. [0.5-5] Hz to the out-of-bound power) from the PPG may indicate of on-body moments. In another example, an overall intensity and patterns in accelerometer and gyroscope data from the IMU may be distinguish between on-body and off-body motions. Any combination of determinations can be used depending on the types of sensors being used and the data being received.

At step 958 the remote device receives one or more high specificity on or off labels from the remote on-body detection module, for example, as discussed with respect to FIG. 7. At step 960 the remote device updates the one or more high sensitivity on or off labels using the one or more high specificity on or off labels, for example, as discussed with respect to FIG. 4. The updating can include any combination of steps, for example, the updating can include saving both the original labels (e.g., provided by the wearable device) and the new labels (e.g., determined by the remote on-body detection module) while giving preference to the new labels when providing to other applications. At step 962 the remote device provides the raw data or lightly-processed signal data with the updated high sensitivity on or off labels to one or more downstream applications.

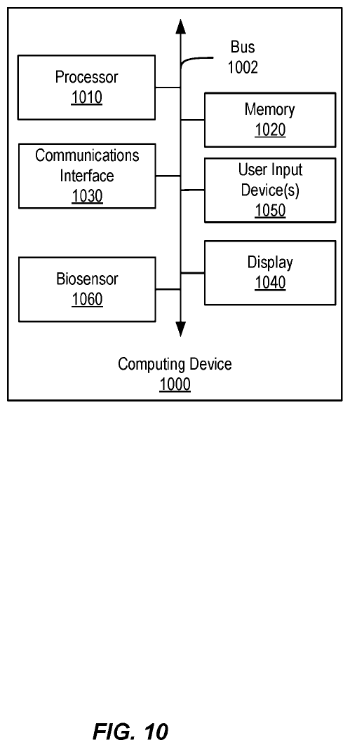

Referring now to FIG. 10, FIG. 10 shows an example computing device 1000 suitable for use in example wearable devices according to this disclosure. The example computing device 1000 includes a processor 1010 which is in communication with the memory 1020 and other components of the computing device 1000 using one or more communications buses 1002. The processor 1010 is configured to execute processor-executable instructions stored in the memory 1020 to perform one or more methods for wearable biosensor devices with adaptive power consumption according to different examples described above with respect to FIGS. 1A-9B. The computing device, in this example, also includes one or more user input devices 1050, such as a keyboard, mouse, touchscreen, microphone, etc., to accept user input. The computing device 1000 also includes a display 1040 to provide visual output to a user.

The computing device 1000 also includes a communications interface 1040. In some examples, the communications interface 1030 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable mediums may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

1. A method comprising:
receiving signal data from a first set of biosensors of a plurality of biosensors in a wearable device;
determining an on-body or an off-body state of the wearable device based on the signal data;
responsive to determining the on-body state, enabling all of the plurality of biosensors on-body to record signal data from the plurality of biosensors;
responsive to determining the off-body state, disabling a second set of the plurality of biosensors to stop recording signal data from the second of the plurality of biosensors;
providing the on-body state or the off-body state to a data analysis engine; and
providing the recorded signal data from the plurality of biosensors to the data analysis engine.

2. The method of claim 1, wherein the first set of biosensors is an electrodermal activity (EDA) sensor and the second set of the plurality of biosensors include at least one of a photoplethysmography (PPG) sensor, an inertial measurement unit (IMU) sensor, and an electrocardiogram (ECG) sensor.

3. The method of claim 2, wherein the signal data from the EDA sensor includes an absolute magnitude at a current time and a standard deviation over a predetermined period of time.

4. The method of claim 3, wherein when the absolute magnitude is greater than approximately 500-800 and the standard deviation is less than 2 over the predetermined period of time of approximately 1400-1600 ms then determine the on-body state.

5. The method of claim 4, further comprising removing off-body labels if a mean value for the absolute magnitude is not equal to zero over the predetermined period of time.

6. The method of claim 1, wherein the wearable device is a smart watch.

7. A device comprising:
a plurality of biosensors;
a non-transitory computer-readable medium; and
a processor communicatively coupled to the plurality of biosensors and the non-transitory computer-readable medium, the processor configured to execute processor-executable instructions stored in the non-transitory computer-readable medium to:
receive signal data from a first set of biosensors of a plurality of biosensors in a wearable device;
determine an on-body or an off-body state of the wearable device based on the signal data;
responsive to determining the on-body state, enabling the plurality of biosensors on-body to record signal data from the plurality of biosensors;
responsive to determining the off-body state, disabling a second set of the plurality of biosensors to stop recording signal data from the second set of the plurality of biosensors;
provide the on-body state or the off-body state to a data analysis engine; and
provide the recorded signal data from the plurality of biosensors to the data analysis engine.

8. The device of claim 7, wherein the first set of biosensors is an electrodermal activity (EDA) sensor and the second set of the plurality of biosensors include at least a photoplethysmography (PPG) sensor, an inertial measurement unit (IMU) sensor, and an electrocardiogram (ECG) sensor.

9. The device of claim 8, wherein the signal data from the EDA sensor includes an absolute magnitude at a current time and a standard deviation over a predetermined period of time.

10. The device of claim 9, wherein when the absolute magnitude is greater than approximately 500-800 and the standard deviation is less than 2 over the predetermined period of time of approximately 1400-1600 ms then determine the on-body state.

11. The device of claim 10, further comprising removing off-body labels if a mean value for the absolute magnitude is not equal to zero over the predetermined period of time.

12. The device of claim 7, wherein the wearable device is a smart watch.

13. A non-transitory computer readable medium configured to store at least executable instructions, wherein the executable instructions, when executed by a processor of a wearable computing device, cause the wearable computing device to perform functions comprising:
receive signal data from a first set of biosensors of a plurality of biosensors in a wearable device;
determine an on-body or an off-body state of the wearable device based on the signal data;
responsive to determining the on-body state, enabling the plurality of biosensors on-body to record signal data from the plurality of biosensors;
responsive to determining the off-body state, disabling a second set of the plurality of biosensors to stop recording signal data from the second set of the plurality of biosensors;
provide the on-body state or the off-body state to a data analysis engine; and
provide the recorded signal data from the plurality of biosensors to the data analysis engine.

14. The non-transitory computer-readable medium of claim 13, wherein the first set of biosensors is an electrodermal activity (EDA) sensor and the second set of the plurality of biosensors include at least a photoplethysmography (PPG) sensor, an inertial measurement unit (IMU) sensor, and an electrocardiogram (ECG) sensor.

15. The non-transitory computer-readable medium of claim 14, wherein the signal data from the EDA sensor includes an absolute magnitude at a current time and a standard deviation over a predetermined period of time.

16. The non-transitory computer-readable medium of claim 15, wherein when the absolute magnitude is greater than approximately 500-800 and the standard deviation is less than 2 over the predetermined period of time of approximately 1400-1600 ms then determine the on-body state.

17. The device of claim 16, further comprising removing off-body labels if a mean value for the absolute magnitude is not equal to zero over the predetermined period of time.

18. A method comprising:
receiving one or more high sensitivity on or off labels from an on-body detection module on a wearable device;
receiving sensor data for one or more biosensors on the wearable device;
providing the sensor data to a remote on-body detection module separate from the wearable device;
receiving one or more high specificity on or off labels from the remote on-body detection module;
updating the on the one or more high sensitivity on or off labels using the one or more high specificity on or off labels; and
providing the signal data with the updated high sensitivity on or off labels to one or more downstream applications.

19. The method of claim 20, further comprising performing a predictive analysis on the updated high sensitivity on or off labels to determine next states of the wearable device.

20. The method of claim 19, wherein:
the predictive analysis employs a hidden Markov model; and
next states include one or more of on-body vigorous motion, on-body light motion, on-body rest, off-body rest, and off-body motion.

21. A system comprising:
a wearable device configures to:
receive signal data from a first set of biosensors of a plurality of biosensors in a wearable device;
determine an on-body or an off-body state of the wearable device based on the signal data;
responsive to determining the on-body state, enabling all of the plurality of biosensors on-body to record signal data from the plurality of biosensors;
responsive to determining the off-body state, disabling a second set of the plurality of biosensors to stop recording signal data from the second of the plurality of biosensors;
provide the on-body state or the off-body state to a data analysis engine; and
provide the recorded signal data from the plurality of biosensors to the data analysis engine; and
the data analysis engine configured to:
receive one or more high sensitivity on or off labels from an on-body detection module on a wearable device;
receiving sensor data for one or more biosensors on the wearable device;
provide the sensor data to a remote on-body detection module separate from the wearable device;
receive one or more high specificity on or off labels from the remote on-body detection module;
update the on the one or more high sensitivity on or off labels using the one or more high specificity on or off labels; and
provide the signal data with the updated high sensitivity on or off labels to one or more downstream applications.
